(19) United States
(12) Patent Application Publication
(10) Pub. No.: US 2026/0056534 A1
(43) Pub. Date: Feb. 26, 2026

(54) Method and Apparatus for the Automated Configuration of Manufacturing Execution Systems

(71) Applicant: Robert Bosch GmbH, Stuttgart (DE)

(72) Inventors: Daniel Seiler-Thull, Ostfildern (DE); Michael Kolb, Wailbingen (DE)

(21) Appl. No.: 19/307,382

(22) Filed: Aug. 22, 2025

(30) Foreign Application Priority Data
Aug. 26, 2024 (DE) 10 2024 208 098.5

(51) Int. Cl. G05B 19/418; G06F 9/445; G06Q 50/04

(52) U.S. Cl. CPC G05B 19/41845; G06F 9/44505; G06Q 50/04

(57) ABSTRACT

A method for the automated configuration of software systems involves processing a configuration request from multiple software agents, each of which has a large language model. Each agent contributes to fulfilling the request based on its role and expertise (domain expert, application expert, configuration expert). The result is a new or adapted configuration of the software system.

This application claims priority under 35 U.S.C. § 119 to application no. DE 10 2024 208 098.5, filed on Aug. 26, 2024 in Germany, the disclosure of which is incorporated herein by reference in its entirety.

The disclosure relates to a method for the automated configuration of manufacturing execution systems (MES) using artificial intelligence (AI), as well as an apparatus, a computer program and a machine-readable storage medium.

### BACKGROUND

A Manufacturing Execution System (MES) is a computerized system used in manufacturing to generally control the conversion of raw materials into finished products. The German term Produktionsleitsystem (production control system) or Fertigungsmanagementsystem (manufacturing management system) is often used as a synonym. The MES is characterized by its direct connection to the distributed systems of process automation compared to similarly effective systems for production planning, the so-called ERP systems (Enterprise Resource Planning), and enables the management, steering, control or monitoring of production in real time by a higher-level control of the machines. This includes classic data acquisition and processing such as production data acquisition (PDA) and machine data acquisition (MDA), but also all other processes that have a real-time impact on the manufacturing/production process. In particular, the MES is used for the continuous execution of existing and valid planning and feedback from the process.

DE 10 2007 045 926 A1 discloses an interface between a production management system and an automation system.

The MES is currently being set up or adapted manually. This task is usually carried out by highly qualified applicators, who undergo very complex qualification measures to put the respective product into use in the factory over a period of weeks or months. The greatest effort is required for the lengthy analysis of the production line, the stations used in it, and the compilation and understanding of manufacturer-specific documentation for machine interfaces and production processes. The resulting understanding is then manually transferred to an MES system-specific configuration. The configuration of the various MES components is usually very heterogeneous and correspondingly complex.

The disadvantage here is that the manual setup and adaptation of MES systems requires a lot of time and personnel due to the high complexity and heterogeneity of the configuration and is therefore hardly scalable.

It is therefore a task of the disclosure to improve scalability for setting up and customizing MES products.

The advantages of the disclosure include reduced time and personnel costs for the configuration of MES systems. The disclosure also enables improved scalability of MES solutions thanks to automation. Another advantage is the reduced susceptibility to errors thanks to automated configuration. The disclosure also enables increased user-friendliness through an intuitive graphical user interface and output of the results via this user interface.

### SUMMARY

In a first aspect, the disclosure relates to a method for the automated configuration of a software system. The software system can be a Manufacturing Execution System (MES), which can be used for manufacturing control. The software system or MES can be configured in terms of a plurality of aspects in order to adapt it to the individual requirements of a manufacturing company and its production processes. The configuration can include both technical and organizational aspects. It is conceivable that a production model of the MES is configured. The production model can define production structures, resources (machines, workstations, personnel) and processes (production lines, work processes, material flow). One or a plurality of data structures may be configured. The data structures determine, for example, how the production data (e.g. quantities, production times, machine data, quality data) is formatted and, if necessary, how it is processed. Furthermore, connections to other IT systems can be configured, such as ERP systems, PLM systems or quality management systems. This means that software interfaces to other software systems or machines can be configured. A user interface of the MES can be configured, in particular by customizing the user interface to the needs of the various user groups and data and/or data formats to be output. Furthermore, notification & alarm management of the MES can be configured, in particular by defining rules for notifications and alarms for critical events in production depending on the different process steps. It is also conceivable that reporting and/or analysis of the MES is configured, in particular by configuring reports and evaluations for monitoring and analyzing production.

The method of the first aspect of the disclosure may begin with an optional step. This involves providing a global configuration model of the software system, which defines configuration parameters and their dependencies. A configuration request is then received, which characterizes or describes a desired change or creation of a configuration of the software system. The configuration request is preferably a textual description of the configuration request, i.e. a text written in a language understandable to a human.

This is followed by processing of the configuration request by a plurality of interacting software agents, each of which uses a large language model (LLM), wherein each agent contributes to fulfilling the configuration request based on its role and expertise. The role and expertise are preferably characterized by a textual description. The textual description is then used to set up the LLM for the corresponding agent with regard to their role and expertise.

It should be noted that the textual descriptions can alternatively be given by voice input.

The agents have the following roles:
At least one domain expert who has expertise of the application domain of the software system and can interpret the configuration request in the context of the specific requirements.
At least one application expert who has detailed knowledge of the software system and its configuration possibilities and can translate the configuration request into concrete configuration parameters.
At least one configuration expert who specializes in creating, optionally validating and optionally documenting the configuration in the specified format of the global configuration model.

Once the agents have finished processing the configuration request, a new or adapted configuration of the software system is generated through the interaction of the agents. Finally, the software system can be set up with the configuration and operated if necessary.

It is suggested that the agents can interact as follows: Exchange of information and knowledge about the configuration request, the application domain and the software system, in particular via a common communication space or communication channel of the agents, discussion and negotiation of configuration options based on the expertise of each agent, in particular in said communication space, and optionally validation of the proposed configuration parameters against the rules and constraints of the global configuration model.

Furthermore, it is proposed that the agents are specialized in that they can access a knowledge database containing relevant documents, instructions, documentation and historical configuration data of the software system. The agents prefer to use retrieval-augmented generation (RAG) techniques to efficiently search the knowledge database for relevant information for configuration and to anchor the outputs of the LLMs based on the knowledge database. The agents are preferably configured to communicate with external systems and APIs in order to obtain additional information or execute actions in the software system.

In a second aspect of the disclosure, it is proposed that a configuration model be created based on the configuration of the software system and that this be output via a graphical user interface. The user interface enables visualization of the current configuration of the software system, manual adjustment of the configuration by a user if necessary and optionally a check and validation of the configuration generated by the agents and/or a comparison of different configuration versions.

In a further aspect of the disclosure, it is proposed that the configured software system is operated in accordance with the first aspect of the disclosure, wherein the software system determines an output variable based on detected sensor variables of one or a plurality of sensors, in particular from production or other input variables, wherein a control variable is output depending on the output variable.

The control variable may be used to control an actuator of a technical system. For example, the technical system may be an at least semiautonomous machine, an at least semiautonomous vehicle, a robot, a tool, a manufacturing or a machine tool, or a flying object such as a drone.

In further aspects, the disclosure relates to an apparatus and to a computer program, which are each configured so as to carry out the aforementioned methods, and to a machine-readable storage medium on which said computer program is stored.

### BRIEF DESCRIPTION OF THE DRAWINGS

Embodiments of the disclosure are explained in greater detail below with reference to the accompanying drawings. The drawings show:

FIG. 1 a schematic visualization of an overall architecture according to an exemplary embodiments of the disclosure

FIG. 2 a schematic visualization of part of the overall architecture

FIG. 3 a schematic visualization of a method, an apparatus and a storage medium of an embodiment of the disclosure.

### DETAILED DESCRIPTION

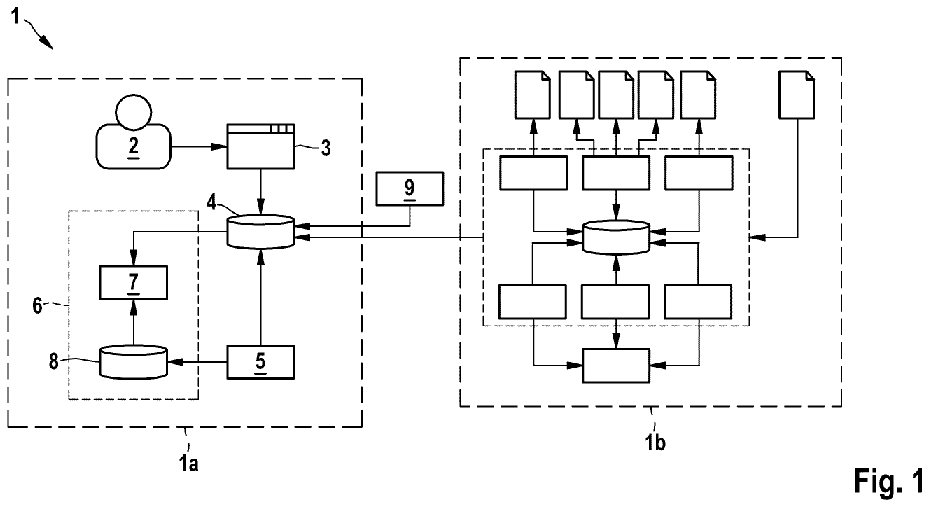

In one embodiment of the disclosure, a GenAI-based low-code MES application 1 is shown in FIG. 1. This generally has two areas: Global configuration management 1a and GenAI-related components 1b.

The global configuration management 1a is designed such that a user 2 can configure all aspects of the MES system, preferably via a graphical abstraction of the complex technical MES configuration elements, also referred to as a “low code front end” 3. The graphical front end 3 is automatically generated and displayed based on the configuration schema stored for the respective MES component. Well-known methods such as ‘react flow’ or similar can be used to generate the graphical representation. Icons or UI elements are used to map production, wherein edges between the elements represent the data flow or other relationships between machines, stations and software components of the MES. Preferably, the configuration schema or configuration is available as a JSON file or in a database. It should be noted that, in addition or as an alternative to graphical abstraction, the configuration schemas can also be output via voice output or another medium.

An example of a graphical representation of a configuration in the configuration schema of an MES component is, for example, a “Cycle time” setting that defines an integer with the unit “seconds”, an upper limit of “86400 seconds” and a lower limit of “10 seconds”. In the graphical representation, an input box can then be displayed via a low-code front end, which allows numerical inputs, e.g. 10<Input<86400 for example. The display of the value can be dynamically expressed in hours, minutes and seconds to optimally support the user.

The set of UI elements is preferably predefined and is applied rule-based to the respective entry in the configuration schema.

In another preferred embodiment, the interface also supports graphical comparison of multiple versions of a configuration. If the user plans a configuration change, for example, he can compare the change graphically with the configuration currently in production (side-by-side or overlay comparison). Changes to individual configuration parameters can be compared via a drill-down and corrected if necessary.

Optionally, the front end 3 can graphically link the physical and logical structure of the plant or production line with the MES components that are relevant for the respective process step.

User 2 also has the option of interacting directly with the GenAI components 1b through a conversation via interface 3. Changes generated in this way are in turn displayed on screen 3 in the graphical comparison. User 2 then prefers to decide which part of the changes should be applied.

The actual configuration of the MES system is maintained, versioned and saved centrally in the “Global Configuration Model” 4. This component also contains the configuration schema required for the UI.

MES components that are not directly based on the standardized configuration schema can be adapted via a “legacy adapter” 6. Adapter 6 generates a component-specific configuration from the generic schema stored in the Global Configuration Model. The adapter comprises a first and second module 7,8, which are referred to as “Configuration Generator” and “MES Legacy Configuration”. Module 7 is set up to translate the Global Configuration into a format that can be used by the Legacy Adapter. Module 8 is set up to display a persisted legacy configuration (e.g. a database entry, a file on hard disk, an environment variable, . . . ).

The MES is shown by reference numeral 5 in FIG. 1.

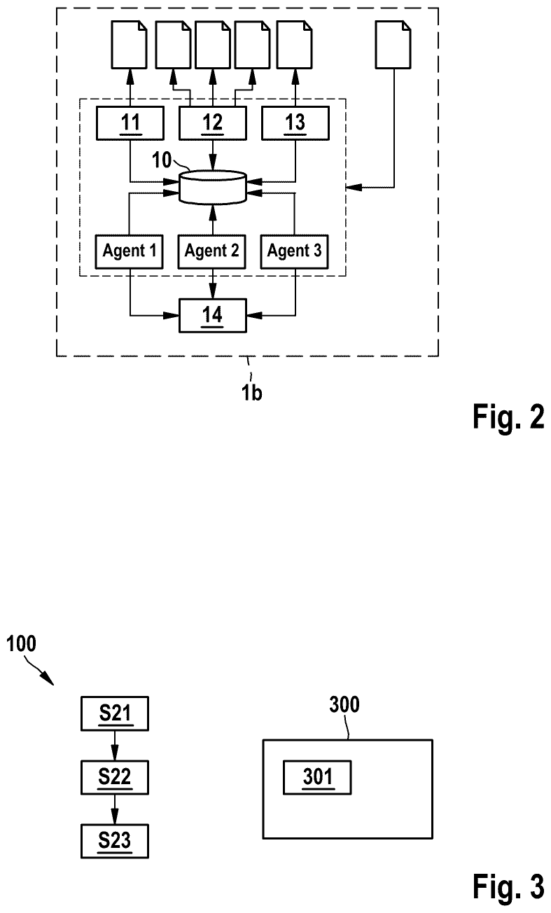

The GenAI-related components 1b are shown on the right-hand side of FIG. 1. This section is shown enlarged in FIG. 2. The interface from global configuration management to the GenAI-related components is provided by an optional “Validator” module 9. Module 9 preferably contains a rule-based and a heuristic check routine to prevent obviously damaged configurations from being applied. It is also conceivable that Module 9 will carry out the validation based on GenAI technologies.

Configurations and configuration changes can be created either manually by the user or fully automatically via the GenAI-based components. In order to achieve the latter, it is proposed according to the disclosure that orchestrated agents are used (“MES Configuration Crew”).

FIG. 2 shows agents 1 to 3 which can access differently configured Large Language Models (LLMs) 14 and which are set up to interact with each other, effectively creating an autonomous system capable of understanding and executing complex tasks. These agents use the capabilities of LLMs to process, understand and respond to natural language. This means that the agents can interpret natural language input and execute actions based on it. Furthermore, these agents are designed to act autonomously. This means they can make decisions and perform tasks without human intervention, based on the information and instructions they receive through natural language. The agents can also interact with a user in real time. It is conceivable that through continuous training and feedback, LLMs and the agents based on them can improve their skills and adapt to new tasks and contexts.

As shown in FIGS. 1 and 2, a plurality of agents are used to automatically discuss a configuration of the MES 5.

In a preferred embodiment, three agents are used that have been initialized as explained below. The initialization can be done by a corresponding text, which is given to the corresponding LLM of the agent to configure the LLM for its role.

Agent 1 is a manufacturing expert. Agent 1 knows the respective production domain and has the corresponding production knowledge. The expertise for the production domain can be given to the LLM through different approaches. One task of this agent is to know and optimize the production facility and the production lines it contains.

Agent 2 is an MES application engineer. Agent 2 is familiar with the MES product and is preferably an LLM specialized in the MES. The task of this agent is to apply the MES product for the respective use case.

Agent 3 is a configuration expert (“Configuration Agent”). Agent 3 is an expert for writing and documenting the MES product-specific configuration. The task of this agent is to read and write the configuration in the specified format and optionally generate human-readable documentation for it.

In addition to the roles of the LLMs by text input (also referred to as context prompting), which describes the role and/or task of the agent, as described above, the LLMs can additionally or alternatively be given their respective properties and/or expertise using other techniques.

One of these techniques is the so-called fine-tuning of the agent's respective LLM. Fine-tuning of LLMs refers to the process of customizing an already pre-trained language model to specific tasks or domains in order to improve its performance in these areas. During fine-tuning, the pre-trained model is further trained with a specific data set that is relevant for the target task or domain. This data can come from various sources. In general, the data for the agents are other documents that are relevant to their tasks. For Agent 1, for example, the data can be data directly from the plant that was generated during production. For Agent 3, the additional data for fine-tuning can be configuration schemas that have already been created.

It turned out that by fine-tuning (especially for agents 1 and 2) with historical production data and data from past application projects, it was possible to achieve above-average precision for their responses.

Known LLMs can be used for the agents. Preferably, a GPT, in particular GPT 4o, or similar is used for Agent 1, and a Mistral Instruct, CodeLlama or similar for Agent 2 and Agent 3.

Another technique besides fine-tuning is the so-called “Retrieval-Augmented Generation” (RAG) and is an approach that combines the strengths of information retrieval systems (retrieval) and generative language models (generation) to improve the quality and relevance of the generated answers.

In general, RAG starts with an input request to which the retrieval module responds by retrieving relevant documents or text passages from a large database. This retrieved information then serves as context for the LLM, which then generates a coherent and well-founded response.

Agent specialisation is achieved through retrieval-augmented generation (RAG), whereby data is processed using a small language model (SLM), for example, so that an LLM can use it to respond to prompts without having to retrain the LLM. User manuals of the MES system, integration guides, process descriptions, documentation from machine manufacturers and other sources are preferably consulted and stored in a database 10 in vectorized form using RAG. Preferably, each agent has its own RAG database, which contains knowledge specialized to the agent's task.

The database 10 or a plurality of databases can be filled using different scrapers 11, 12, 13. For example, a website scraper 11 and a PDF scraper 12 and a code documentation scraper 13 can be used.

In a preferred embodiment of agent 3, it is specialized by way of RAG and a fine-tuning of the LLM. For fine tuning, a plurality of yaml files containing valid deployment configurations for the respective software product can be used, which describe graphs, wherein the graphs describe interactions between modules of the MES.

Optionally, so-called tools may be predefined for the agent. These tools are programs that the respective agent can execute on its own and decide independently when to run them.

It is conceivable that only two agents are used. Only the Manufacturing Expert and MES Application Engineer are preferred here. In this case, the latter could also take over the tasks of the configuration agent. However, it is also conceivable that more than three agents are used. Preferably, a further agent is added to the agents described above, e.g. a “cost manager”, which ensures that only configurations are created that are within a predefined cost range.

The described agents 1 to 3 are each assigned a task and solve it together to produce the best possible result. The task can either be specified by the user (e.g. via chat interaction on the front end) or via recurring and predefined routine tasks from the system operator or product manufacturer.

The tasks can be formulated as follows:
“Create an initial MES configuration for production line XY”.
“Extend the currently valid configuration to map the packaging process described in the following document”
“Migrate the configuration to ensure its compatibility with NEXEED IAS 2025.01”

The agents exchange information according to their tasks and expertise and create a customized version of the configuration. This is created as a new configuration version in Global Configuration Management and optionally presented to the user for checking.

It should be noted that the idea according to the disclosure can alternatively be used to configure any complex software system, in particular as soon as the necessary documents such as instructions for the software system are available.

FIG. 3 shows a schematic flow chart of a computer-implemented method (100) for the automated configuration of a software system, in particular a manufacturing execution system (MES). The method (100) is characterized by the use of interacting software agents, each of which uses a large language model (LLM) and contributes to fulfilling the configuration requests based on its role and expertise. In order to maximize the performance of the agents, they can also be specialized in their respective roles through fine-tuning and are given access to a knowledge database with relevant documents, instructions and historical configuration data. Each agent has its own specialized LLM that has been fine-tuned with data relevant to its role. Communication between the agents takes place via a central communication channel in which the agents exchange information and interim results.

The method (100) begins upon receiving (S21) a configuration request. This request can be transmitted to the system in different ways, for example by direct input from a user via a graphical user interface, by importing from a file or by automated triggers, for example due to corresponding changes in the system. The configuration request itself can contain both natural language descriptions of the desired changes and formal specifications in a language that the system can understand.

In the next step (S22), the configuration request is forwarded to the software agents involved and processed by them. The agents are the domain expert, application expert and configuration expert described above.

Each agent analyzes the configuration request from its own perspective and generates its own suggestions and solutions. These are shared and discussed with the other agents via the central communication channel. Through iterative negotiations and validations of the proposed configuration parameters, the agents gradually approach an (optimal) solution.

The domain expert validates, for example, whether the proposed configurations are compatible with the production processes and guidelines. The application expert checks the technical feasibility and consistency of the configuration parameters in the MES system. The configuration expert ensures that the final configuration complies with the specifications of the global configuration model and is correctly documented.

Throughout the process, agents can also access the central knowledge database to research missing information, consult best practices or analyze historical configurations. For example, the domain expert can access documentation from machine manufacturers to check the compatibility of a new machine with the existing production system. The application expert can access code examples and configuration templates to simplify the implementation of configuration changes in the MES system.

In the last step (S23) of the method (100), the final configuration consolidated by the agents is saved in the global configuration model of the software system. Optionally, the configuration can be validated by a user or activated directly in the MES system.

Furthermore, FIG. 3 shows an apparatus (300) configured to carry out the method 100 with a machine-readable storage medium (301) on which a computer program is stored. The computer program comprises instructions that, when the program is executed by a computer, cause the computer to carry out the method 100.

What is claimed is:

1. A computer-implemented method for automated configuration of a software system, comprising:
receiving a configuration request that describes a desired change or creation of a configuration of the software system;
processing the configuration request by a plurality of interacting software agents utilizing at least one large language model, wherein each agent contributes to fulfilling the configuration request based on its role and expertise, wherein the agents have at least the following roles:
a domain expert who has expertise in the application domain of the software system, an application expert who has knowledge of the software system and its configuration possibilities and can translate the configuration requests into concrete configuration parameters, and a configuration expert who can create configurations in the specified format of the global configuration model; and
generating a new or customized configuration of the software system through interaction of the agents.

2. The method according to claim 1, wherein the interaction of the agents comprises at least the following interaction possibilities: a) exchange of information and knowledge about the configuration request, the application domain and the software system; and b) discussion and negotiation of configuration options based on the expertise of each agent.

3. The method according to claim 1, wherein the agents additionally have the following properties: a) access to a knowledge database containing relevant documents, instructions, best practices and historical configuration data of the software system; b) use of retrieval-augmented generation techniques to search the knowledge database; communication with external systems and APIs to obtain additional information about the software system.

4. The method according to claim 1, wherein a graphical user interface provides the global configuration model, which enables the following: a) visualisation of the current configuration of the software system; b) manual adjustment of the configuration by a user; c) checking and validation of the configuration generated by the agents; and d) comparison of different configuration versions.

5. The method according to claim 1, wherein the software system is a manufacturing execution system, and the application domain comprises manufacturing control.

6. An apparatus which is configured to carry out the method according to claim 1.

7. A computer program comprising instructions which, when the program is executed by a computer, prompt the latter to carry out the method according to claim 1.

8. A machine-readable storage medium on which the computer program according to claim 7 is stored.

9. Use of the determined configuration with the method according to claim 1 in the software system.

10. The method according to claim 1, wherein the interaction of the agents comprises at least the following interaction possibilities: a) exchange of information and knowledge about the configuration request, the application domain and the software system; b) discussion and negotiation of configuration options based on the expertise of each agent and, c) validation of the proposed configuration parameters against the rules and constraints of the global configuration model.
